(19) United States
(12) Patent Application Publication
(10) Pub. No.: US 2026/0244183 A1
(43) Pub. Date: Aug. 20, 2026

(54) WORKFLOW FOR EFFICIENT PARAMETERIZATION OF A NUMERICAL CONTROL SYSTEM

(71) Applicant: Siemens Aktiengesellschaft, 80333 München (DE)

(72) Inventors: ALEXANDER KUBIK, Erlangen (DE); THEO REICHEL, Forchheim (DE); SILKE STOPFER, Erlangen (DE)

(73) Assignee: Siemens Aktiengesellschaft, 80333 München (DE)

(21) Appl. No.: 19/165,014

(22) PCT Filed: Dec. 5, 2023
(86) PCT No.: PCT/EP2023/084289

§ 371 Date: Sep. 12, 2025

(30) Foreign Application Priority Data
Mar. 14, 2023 (EP) 23161823.2

(51) Int. Cl. G05B 19/402

(52) U.S. Cl. CPC G05B 19/402; G05B 2219/37077; G05B 2219/43065

(57) ABSTRACT

For parameterizing a numerical control system, a computing device executes a workflow in which jerk limit values and filter frequencies for position-controlled axes are determined and transmitted to the numerical control system. The computing device first transmits movement commands and receives resulting time curves for the actual position values of the position-controlled axes, on which basis the lowest characteristic frequencies of the position-controlled axes are determined. The position-controlled axes are then sequentially selected, with an operator determining a corresponding jerk limit value and a corresponding filter frequency. Respective lower and upper limits are determined by the computing device. For the first-selected position-controlled axis, the lowest characteristic frequency determines the lower and upper limits. For the other position-controlled axes, the lowest characteristic frequency of each selected axis and the jerk limit value or the filter frequency of the first-selected position-controlled axis are taken into account when determining the lower/upper limits.

The present invention is based on a parameterization method for a numerical control system,
wherein in normal operation the numerical control system moves a tool of the machine tool relative to a workpiece to be machined by the tool along an actual path by coordinated control of multiple position-controlled axes of a machine tool, so that a maximum deviation of the actual path from an actually intended desired path which is defined by a parts program is adhered to,
wherein in normal operation the numerical control system adheres to jerk limit values of the position-controlled axes when moving the position-controlled axes, and filters desired position values of the position-controlled axes before determining control values of the position-controlled axes in setpoint filters,
wherein before normal operation is executed in a computing device coupled to the numerical control system, the jerk limit values for the position-controlled axes and filter frequencies for the setpoint filters are determined as part of a workflow and the computing device transmits the jerk limit values and the filter frequencies to the numerical control system.

The present invention is also based on a computer program, which includes machine code that can be processed by a computing device which can be coupled to a numerical control system, wherein the processing of the machine code by the computing device causes the computing device to execute such a parameterization method.

The present invention is further based on a computing device that can be coupled to a numerical control system and is programmed with such a computer program, so that in operation it executes such a parameterization method.

Such parameterization methods and the associated computer programs and computing devices are generally known.

It is known from DE 102 00 680 A1, in the case of a machine tool with multiple position-controlled axes, to specify jerk limits and to adjust jerk profiles and thereby to influence a filtering effect of the jerk limit. The corresponding adjustments are made separately for each relevant axis of the machine tool. A similar disclosure is to be taken from DE 103 15 525 A1.

Known from EP 4 130 902 A1 is an operating procedure for a manufacturing machine. As part of this operating procedure, maximum values for acceleration and jerk can be determined before an identification run. During the identification run, different operating variables are captured and a current limit and/or torque limit of the drive producing the travel is determined therefrom. Other parameters can also be determined, in particular the maximum permissible jerk for subsequent operation. EP 4 130 902 A1 also mentions that desired position value filters can be used for regular ongoing operation. The associated machine can include multiple position-controlled axes.

Known from DE 10 2017 106 559 A1 is a method in which a jerk limit value is continuously updated in ongoing operation of a numerical control system.

It is known from EP 2 624 090 A1 for the jerk of a traverse movement of a drive controller to be limited, wherein the specific course of the jerk is determined such that an excitation of oscillations is suppressed.

Machine tools are complex mechatronic systems capable of oscillation. To be able to follow an intended desired path with sufficient accuracy (and to be able to apply a desired contour to a workpiece) it is among other things necessary for the relevant position-controlled axes of the machine tool and also of the machine frames to oscillate as a whole only with relatively low amplitudes, so that the necessary contour accuracy is maintained. This applies especially if for example very homogeneous surfaces have to be produced by milling for what is known as mold construction.

In the prior art, it is known among other things for the jerk with which the position-controlled axes are moved to be limited in order to prevent vibrations. It is also known for the desired position values of the axes to be filtered in setpoint filters.

Ascertaining or determining the jerk limit values and the filter frequencies is a challenging task, which can often only be achieved by designated mechatronics experts in an appropriate manner.

At this point it may be noted that independent of the grammatical term usage of a particular personal term (such as here for example the term “mechatronics expert”), individuals with male, female or other gender identities are also included.

The object of the present invention is to create opportunities, by means of which the jerk limit values for the desired position values of the position-controlled axes and the filter frequencies of the setpoint filters can be determined such that on the one hand the path can be followed as dynamically as possible and on the other hand the maximum deviation is adhered to, The determination should be effected as efficiently as possible, in particular with as small as possible a number of individual steps. It should furthermore be possible for the jerk limits and the filter frequencies to be ascertained not only by designated mechatronics experts, but also by a commissioning engineer of the machine tool.

The object is achieved by a parameterization method having the features of claim 1. Advantageous embodiments of the parameterization method are the subject matter of the dependent claims 2 to 8.

In accordance with the invention an operating procedure of the type mentioned in the introduction is embodied, in that
as part of the processing of the workflow the computing device
   on the basis of an input by an operator determines movement commands for the position-controlled axes and transmits them to the numerical control system, so that the numerical control system moves the position-controlled axes in accordance with the transmitted movement commands, and from the numerical control system receives time curves produced by the movement commands for the actual position values of the position-controlled axes,
   based on the received time curves of the actual position values determines lowest characteristic frequencies of the position-controlled axes or outputs a preliminary evaluation of the time curves of the actual position values to the operator and receives such a determination from the operator,
   selects the position-controlled axes one after the other and from the operator receives a determination of the jerk limit value and of the filter frequency for the respectively selected position-controlled axis and
   transmits the determined jerk limit values and the determined filter frequencies to the numerical control system,
the computing device permits the determination of the respective jerk limit value only between a respective lower jerk limit and a respective upper jerk limit and permits the determination of the respective filter frequency only between a respective lower frequency limit and a respective upper frequency limit,
for the first-selected position-controlled axis, the computing device determines the lower jerk limit and the upper jerk limit as well as the lower frequency limit and the upper frequency limit by taking into account the lowest characteristic frequency of the first-selected axis and
for the other position-controlled axes, the computing device determines the lower jerk limit and/or the upper jerk limit by taking into account the lowest characteristic frequency of the respective selected axis and the jerk limit value determined for the first-selected position-controlled axis and determines the lower frequency limit and/or the upper frequency limit by taking into account the lowest characteristic frequency of the respective selected axis and the filter frequency determined for the first-selected position-controlled axis.

The movement commands for the position-controlled axes, which the computing device determines at the start of the workflow, are mostly multiple short jerk-like movements, wherein the extent of movement (i.e. the traverse path) and/or the jerk are varied from movement to movement. For example, three movements with paths of 1 mm, 3 mm and 10 mm can be specified, wherein in all three cases the jerk is limited to 100 m/s³. The values mentioned are of course only purely by way of example. It is possible for the movements as such to be permanently specified, so that the input by the operator merely triggers the transmission of the movement commands to the numerical control system. It is also possible for the movements as such already to be present in the control device in parameterized form, so that the inputs by the operator are only a few parameters of the movement. Likewise it is possible for the inputs by the operator to specify the movement directly.

Various procedures are possible for the determination of the lowest characteristic frequencies of the position-controlled axes on the basis of the captured time curves of the actual position values, In some circumstances, it may be possible for the computing device to perform an automatic evaluation. For example, the computing device can—separately for each position-controlled axis—automatically perform a frequency analysis, on the basis of the frequency analysis determine the characteristic frequencies of the respective position-controlled axis, and assign the lowest characteristic frequency found for the respective position-controlled axis to the respective position-controlled axis. Alternatively the computing device can for example—again separately for each position-controlled axis—perform a frequency analysis of the time curves of the actual position values and display the respective frequency analysis to the operator via a user interface. In this case an intellectual evaluation of the respective frequency analysis can be effected by the operator, so that the operator of the computing device specifies the characteristic frequencies of this position-controlled axis or at least the lowest characteristic frequency of this position-controlled axis. However, regardless of whether one or the other procedure is taken, the lowest characteristic frequencies of the position-controlled axes are known to the computing device after the determination.

The purpose of selecting the first position-controlled axis is to select the position-controlled axis in which the lowest characteristic frequency has the smallest value. Thus if—for example—three position-controlled axes are present and the lowest characteristic frequency of axis 1 is 12 Hz, the lowest characteristic frequency of axis 2 is 20 Hz and the lowest characteristic frequency of axis 3 is 25 Hz, then axis 1 is selected.

In certain cases it may be permissible to select a different axis. However, this is permissible only if multiple position-controlled axes exist, which as it were compete as to which now has exactly the lowest characteristic frequency with the smallest value. If the lowest characteristic frequencies of the axes 1, 2 and 3 are for example 12.5 Hz, 12.8 Hz and 20 Hz, it is essentially equivalent to select axis 1 or axis 2 first. In contrast, axis 3 should not be selected first.

Analogously to the determination of the lowest characteristic frequencies, various procedures are likewise possible for the selection of the first position-controlled axis. Due to the fact that the lowest characteristic frequencies of the position-controlled axes are already known to the computing device, an automatic selection by the computing device is easily possible. However, it is likewise possible for the operator to specify which position-controlled axis is selected. In this case the selection made by the operator must ensure that the first-selected position-controlled axis is the position-controlled axis whose lowest characteristic frequency has the smallest value.

Various procedures are possible for the determination of the respective jerk limit value and the respective filter frequency. Advantageous embodiments will be discussed here later. It is crucial for the computing device to determine the respective lower limits and upper limits for the jerk limit value and the filter frequency, so that a setting by the operator is possible only within the respectively specified interval. It is furthermore important for the lower limits and the upper limits to be determined exclusively by the lowest characteristic frequency of the first-selected axis only for the first-selected axis. In contrast, for the further axes the computing device also additionally takes into account for the determination of the lower limits and/or the upper limits the jerk limit value determined for the first-selected position-controlled axis or the filter frequency determined for the first-selected position-controlled axis. For this reason it is also necessary for the first-selected position-controlled axis to be the axis in which the lowest characteristic frequency has the smallest value.

The computing device preferably first receives the determination of the jerk limit value from the operator for the respectively selected position-controlled axis and only thereafter the determination of the filter frequency. As a result, repercussions of the filter frequency on the appropriate determination of the jerk limit value are in particular prevented.

To determine the respective jerk limit value the computing device preferably first deactivates the respective setpoint filter and then iteratively executes the following steps:
it receives a determination of the jerk limit value from the operator,
limited to the jerk limit value received, it initiates movements of the respective position-controlled axis,
it displays to the operator the thereby effected time curve of the actual position value of the respective position-controlled axis.

These steps are executed Iteratively over and over again until a command to adopt the last jerk limit value received is specified by the operator to the computing device as a determined jerk limit value.

Before the first determination by the operator, the computing device preferably sets the jerk limit value to an initial jerk, limited to the initial jerk initiates movements of the respective position-controlled axis, and displays to the operator the thereby effected time curve of the actual position value of the respective position-controlled axis. As a result, in many cases a multiple pass through the loop comprising determination of the jerk limit value, initiation of the respective movement and display of the time curve of the actual position value can be prevented, because either the initial jerk can already be adopted as a determined jerk limit value or at least the first determination of the jerk limit value by the operator already results in the desired success.

The computing device preferably sets the initial jerk to a value—in particular a mean value—between the lower jerk limit and the upper jerk limit of the selected position-controlled axis. Here there is the highest probability that the initial jerk can already be adopted as a determined limit value. For example, the computing device can determine the initial jerk as a function of the lowest characteristic frequency of the selected position-controlled axis.

In an analogous manner the computing device activates the respective setpoint filter to determine the respective filter frequency and then iteratively executes the following steps:
it receives a determination of the filter frequency from the operator,
limited to the determined jerk limit value and taking into account the received filter frequency it initiates movements of the respective position-controlled axis,
it displays to the operator the thereby effected time curve of the actual position value of the respective position-controlled axis.

These steps are executed iteratively over and over again until a command to adopt the last filter frequency received is specified by the operator to the computing device as a determined filter frequency.

Before the first determination by the operator, the computing device preferably sets the filter frequency to an initial frequency, limited to the determined jerk limit value and taking into account the initial frequency initiates movements of the respective position-controlled axis, and displays to the operator the thereby effected time curve of the actual position value of the respective position-controlled axis. As a result, in many cases a multiple pass through the loop comprising determination of the filter frequency, initiation of the respective movement, and display of the time curve of the actual position value can be prevented, because either the initial frequency can already be adopted as a determined filter frequency or at least the first determination of the filter frequency by the operator already results in the desired success.

The computing device preferably sets the initial frequency to a value—in particular a mean value—between the lower frequency limit and the upper frequency limit of the selected position-controlled axis. Here there is the highest probability that the initial frequency can already be adopted as a determined filter frequency. For example, the computing device can determine the initial frequency as a function of the lowest characteristic frequency of the selected position-controlled axis.

The object is furthermore achieved by a computer program with the features of claim 9. In accordance with the invention, the processing of the computer program by the computing device causes the computing device to execute an inventive parameterization method.

The object is furthermore achieved by a computing device with the features of claim 10. In accordance with the invention, the computing device is programmed with an inventive computer program, so that in operation the computing device executes an inventive parameterization method.

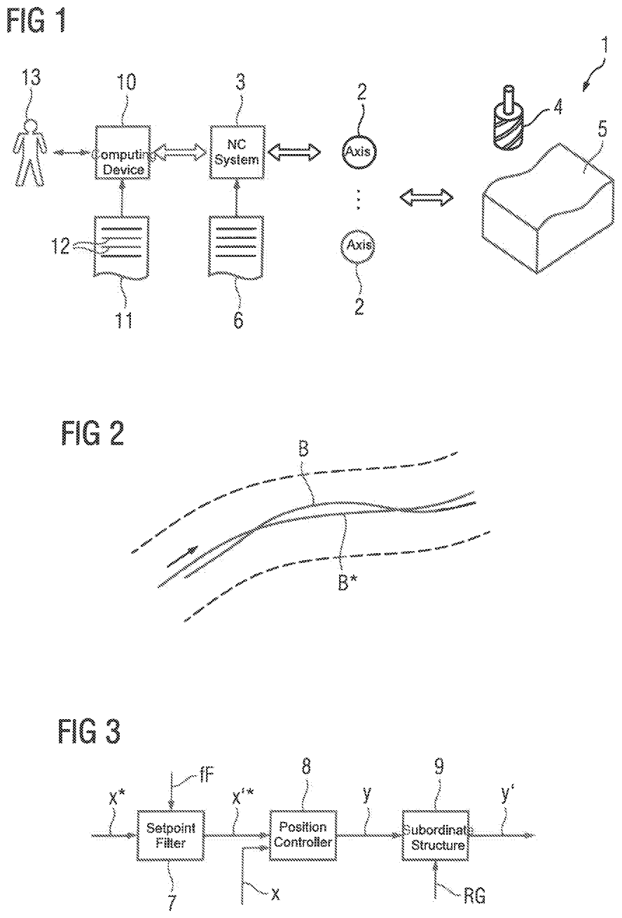

The above-described properties, features and advantages of this invention and the manner in which they are achieved will become clearer and more readily understandable in connection with the following description of the exemplary embodiments, which are explained in greater detail in connection with the drawings, which in a schematic representation show:
FIG. 1 a machine tool, a numerical control system, and a computing device,

FIG. 2 sections of paths,

FIG. 3 a control structure of a position-controlled axis,

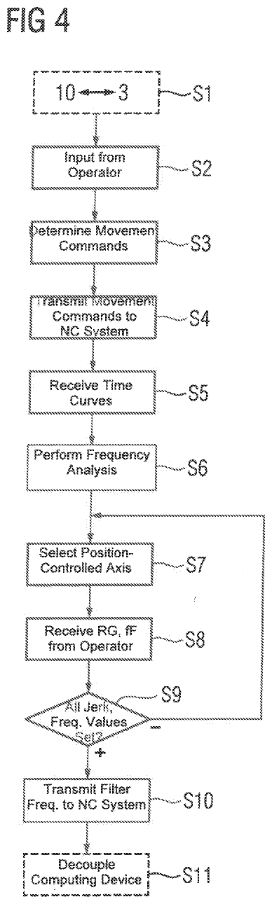

FIG. 4 a flow diagram,

FIG. 5 a frequency response,

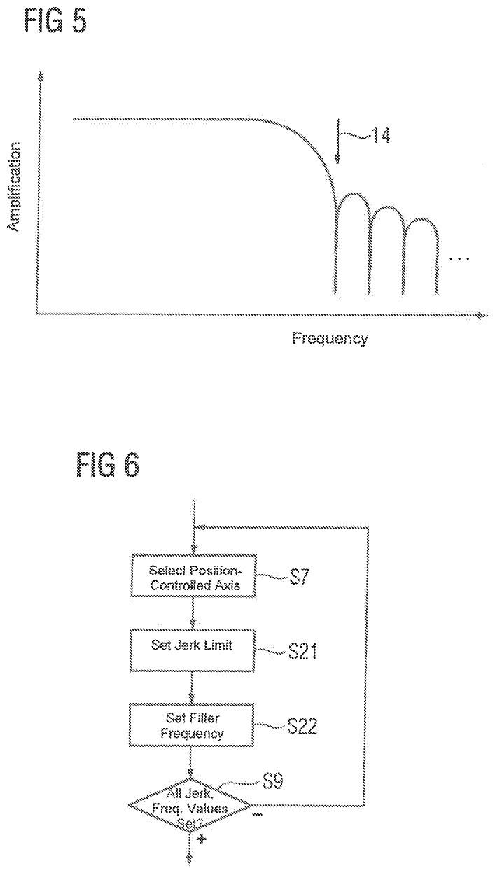

FIG. 6 a flow diagram,

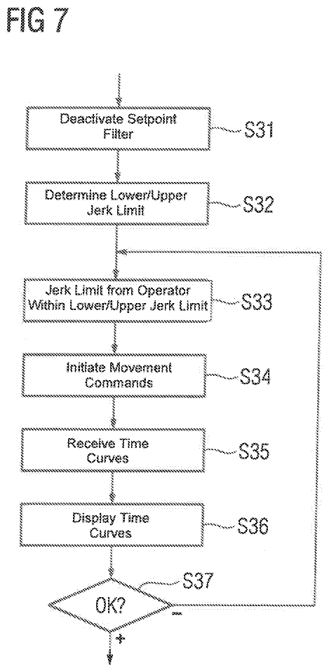

FIG. 7 a flow diagram,

FIG. 8 a time diagram,

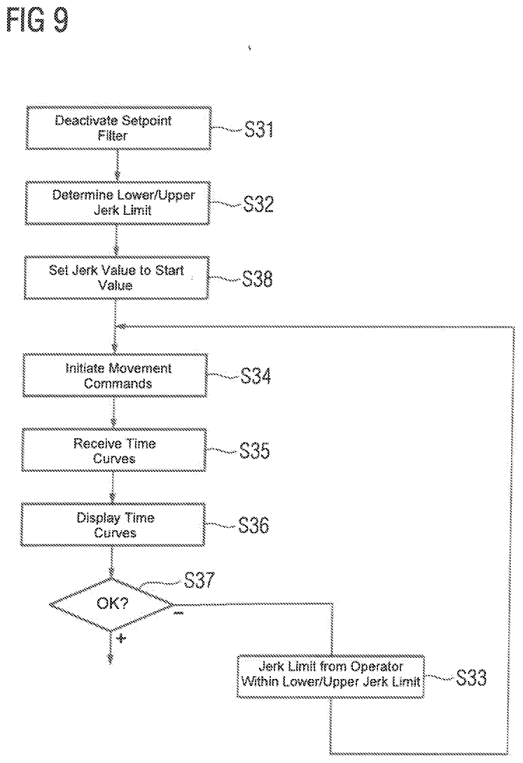

FIG. 9 a flow diagram,

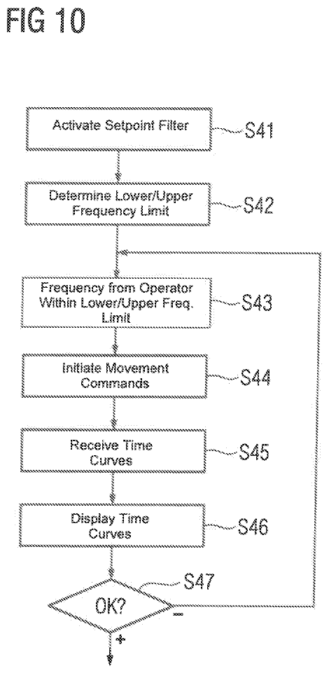

FIG. 10 a flow diagram, and

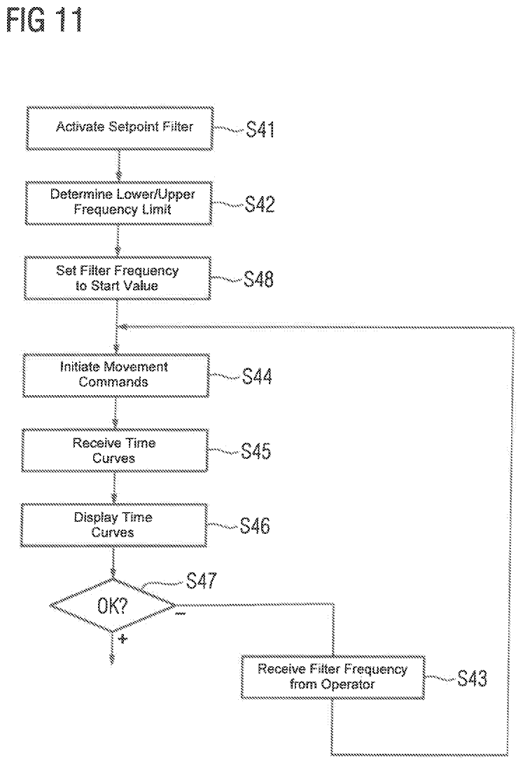

FIG. 11 a flow diagram.

In accordance with FIG. 1 a machine tool 1 has multiple position-controlled axes 2. At least the position-controlled axes 2 are controlled by a numerical control system 3. In normal operation the numerical control system 3 controls the position-controlled axes 2 in a coordinated manner. Due to the coordinated control of the position-controlled axes 2 a tool 4 of the machine tool 1 (for example a milling cutter) is moved relative to a workpiece 5 along an actual path B (see FIG. 2). As a result, the workpiece 5 is machined by means of the tool 4.

FIG. 2 shows by way of example a section of a desired path B *. The desired path B* is defined by a parts program 6 (see FIG. 1) with which the numerical control system 3 is programmed. The desired path B* is the actually desired path, along which the tool 4 is to be moved relative to the workpiece 5. In practice the actual path B deviates slightly from the desired path B*. However, the movement of the tool 4 relative to the workpiece 5 is always effected such that a maximum deviation of the actual path B from the desired path B* is adhered to. For example, the movement of the tool 4 relative to the workpiece 5 is effected such that the actual path B always moves around the desired path B* within a sleeve defined by the maximum deviation. The sleeve is indicated in FIG. 2 by dashed lines.

As part of the control of the individual position-controlled axes 2, in accordance with FIG. 3 the numerical control system 3 generates an operational sequence of desired position values x* for the respective position-controlled axis 2. The operational sequence of desired position values x* is passed to a respective setpoint filter 7, which is realized within the numerical control system 3. In the respective setpoint filter 7 a filtering of the respective operational sequence of desired position values x* is effected on the basis of a respective filter frequency fF. The filtered desired position values are designated below by the reference character x **.

The filtered desired position values x** are linked in a respective position controller 8 to the associated actual position values x and thus an output signal y of the position controller 8 is generated, which is likewise realized within the numerical control system 3. The output signal y of at least one subordinate structure 9 is further processed, so that the output signal y becomes a modified output signal y′. Among other things, a limitation of the jerk is effected, so that the current jerk (in terms of absolute value) is at any time limited to a respective jerk limit value RG. Thus in normal operation when moving the position-controlled axes 2 the numerical control system 3 adheres to the jerk limit values RG of the position-controlled axes 2. On the basis of the respective modified output signal y′ the respective control signals are determined for the drive of the respective position-controlled axis 2.

The precise manner of filtering in the setpoint filter 7 is of secondary importance. FIR filtering (FIR=finite impulse response) is often effected in the setpoint filter 7. Regardless of the specific embodiment of the setpoint filter 7, the precise embodiment of the setpoint filter 7 often depends on many individual parameters. However, procedures are known to persons skilled in the art of merely determining the filter frequency IF and then determining the parameters of the setpoint filter 7 as a function of the filter frequency fF.

The determination of the jerk limit values RG and the filter frequencies fF is effected—individually for the respective position-controlled axis 2—in a computing device 10 before the execution of normal operation (see FIG. 1). The transmission of the determined jerk limit values RG and the determined filter frequencies fF to the numerical control system 3 is also effected by the computing device 10. For this purpose the computing device 10 is coupled to the numerical control system 3. The computing device 10 is programmed with a computer program 11. The computer program 11 Includes machine code 12 that can be processed by the computing device 10. Because the computing device 10 is programmed with the computer program 11 or the machine code 12 is processed by the computing device 10 the computing device 10 executes a parameterization method. The parameterization method and the associated workflow are explained in greater detail below in connection with FIG. 4 and the further figures.

In accordance with FIG. 4 the computing device 10 is first coupled to the numerical control system 3 in a step S1. The coupling is generally not realized exclusively by the computing device 10, but at least in part by an operator 13 (see FIG. 1). The step S1 is hence represented in FIG. 4 only as a dashed line.

In a step S2 the computing device 10 receives an input from the operator 13. Due to the input the computing device 10 determines movement commands for the position-controlled axes 2 in a step S3, and transmits the movement commands to the numerical control system 3 in a step S4. As a result, the numerical control system 3 moves the position-controlled axes 2 in accordance with the transmitted movement commands. For example, the computing device 10 can, as movement commands per position-controlled axis 2, determine a number of short, jerky movements and transmit them to the numerical control system 3, wherein the traverse path and/or the jerk are changed from jerky movement to jerky movement. Typical movement commands are movement commands with a traverse path of a few millimeters in the case of a jerk between 80 m/s³ and 200 m/s³. For example, for the respective position-controlled axis 2 the computing device 10 can in each case determine a movement command with a traverse path of 1 mm, 3 mm and 10 mm, wherein the jerk for the movement commands is uniformly 100 m/s³. The numerical values mentioned are only purely by way of example.

The movement commands are converted into actual controls of the position-controlled axes 2 in the numerical control system 3. The corresponding function generators for wideband excitation are typically present in the numerical control system 3.

In a step S5 the computing device 10 receives from the numerical control system 3 the time curves of the actual position values x of the position-controlled axes 2, which are produced by the movement commands. In a step S6 building thereon, in other words based on the received time curves of the actual position values x, a frequency analysis is effected with a determination, based thereon, of lowest characteristic frequencies fE of the position-controlled axes 2.

To implement step S6 it is possible for the computing device 10 itself to perform the corresponding frequency analysis and determination. Alternatively it is possible for the computing device 10 to perform a preliminary evaluation of the time curves of the actual position values x, in particular to determine a frequency response by frequency analysis (see by way of example FIG. 5, in which the frequency is shown in Hz on the abscissa and the amplification in dB on the ordinate). In this case the computing device 10 outputs the preliminary evaluation (for example the frequency response) to the operator 13. The operator 13 is thus able to determine the lowest characteristic frequency fE for the respective position-controlled axis 2. The determination can for example be effected by inputting a numerical value or by positioning a cursor 14. The corresponding determination of poles and zeros in the frequency diagram is known generally to persons skilled in the art and may even be automated.

For the sake of good order, it should be noted that although multiple characteristic frequencies can be defined for the position-controlled axes 2, only the lowest characteristic frequency fE of the respective position-controlled axis 2 is relevant in the present case. Here is a numerical example:

Suppose there are a total of three position-controlled axes 2 present. One of the position-controlled axes 2 has the characteristic frequencies 12 Hz, 17 Hz, 24 Hz, 30 Hz and values above this. Another of the position-controlled axes 2 has the characteristic frequencies 20 Hz, 27 Hz, 34 Hz, 40 Hz and values above this. The last of the position-controlled axes 2 has the characteristic frequencies 25 Hz, 33 Hz, 40 Hz, 50 Hz and values above this, Then for the former position-controlled axis 2 the lowest characteristic frequency fE is 12 Hz, for the second position-controlled axis 2 it is 20 Hz, and for the latter position-controlled axis 2 it is 25 Hz.

In a step S7 one of the position-controlled axes 2 is selected. On the first execution of step S7 the position-controlled axis 2 should be selected which has the lowest characteristic frequency fE with the smallest value, I.e. in accordance with the above example the position-controlled axis 2, whose lowest characteristic frequency fE is 12 Hz.

For the selected position-controlled axis 2, in a step S8 the computing device 10 receives from the operator 13 a determination of the jerk limit value RG and a determination of the filter frequency fF. The implementation of step S8 will be explained below in greater detail.

In a step S9 the computing device 10 checks whether the jerk limit value RG and the filter frequency fF have been determined for all position-controlled axes 2. If not, the computing device 10 returns to step S7. When executing step S7 again, another of the position-controlled axes 2 is selected for which the jerk limit value RG and the filter frequency fF are not yet determined. In contrast, if the determination has already been effected for all position-controlled axes 2, the determined jerk limit values RG and the determined filter frequencies fF are transmitted to the numerical control system 3 by the computing device 10 in a step S10. The determinations, building on the determined filter frequencies fF, of the Individual parameters of the setpoint filters 7 are effected in the numerical control system 3. The corresponding determinations are standard practice and hence do not need to be explained in detail,

With the execution of step D10 the parameterization method is completed. The computing device 10 is then merely decoupled from the numerical control system 3 in a step S11. The decoupling is generally realized not exclusively by the computing device 10, but at least in part by the operator 13. Step S11 is hence only shown as a dashed line, analogously to step S1 in FIG. 4.

In accordance with FIG. 6, step S8 is generally divided into two separate steps S21 and S22. In step S21 the respective jerk limit value RG is determined. In step S22 the respective filter frequency fF is determined. Step S21 is preferably executed before step S22. In this case, when executing step S22, the jerk limit value RG determined in step S21 is already taken into account.

Below, in connection with FIGS. 7 to 9, a possible (and currently preferred) implementation of step S21 is first explained. Then in connection with FIGS. 10 and 11, a possible (and currently preferred) implementation of step S22 is explained.

In accordance with FIG. 7 the computing device 10 first deactivates the setpoint filter 7 of the selected position-controlled axis 2 in a step S31. For example, the computing device 10 can transmit a corresponding control signal to the numerical control system 3. In a step S32 the computing device 10 determines a lower jerk limit RUG and an upper jerk limit ROG for the selected position-controlled axis 2.

In a step S33 the computing device 10 receives a determination of the jerk limit value RG from the operator 13. The specification of the jerk limit value RG by the operator 13 is here permissible only within the interval determined by the lower jerk limit RUG and the upper jerk limit ROG. The specification of a jerk limit value RG by the operator 13 outside the interval determined by the lower jerk limit RUG and the upper jerk limit ROG is refused by the computing device 10. In a step S34 the computing device 10—similarly to steps S3 and S4 in FIG. 4—initiates movements of the respective position-controlled axis 2. For these movements the computing device 10 limits the jerk to the jerk limit value RG received in step S33.

In a step S35 the computing device 10—similarly to step S5 in FIG. 4 receives from the numerical control system 3 the time curves of the actual position values x of the selected position-controlled axis 2 which are produced or effected by the movement commands of step S34. In a step S36 the computing device 10 displays the corresponding time curve of the actual position value x of the respective position-controlled axis 2. FIG. 8 shows a possible curve with an oscillation of the actual position value x around the associated desired position value x* as a function of the time t. Where appropriate, the area with the highest vibration amplitude can be visually highlighted in the display.

In a step S37 the computing device 10 checks whether an OK signal has been specified to it by the operator 13. If so, the computing device 10 adopts the last-received jerk limit value RG as a determined jerk limit value RG. Otherwise the computing device 10 returns to step S33 and receives from the operator 13 a modified determination of the jerk limit value RG. It is possible that when step S33 is executed anew (within the permissible interval) a free specification of the jerk limit value RG is possible. Preferably, however, based on the last-specified jerk limit value RG, only a change by a certain extent is possible, for example by a maximum of 5% or a maximum of 10% or a maximum of 20% of the size of the permissible interval.

FIG. 9 shows a slight modification of the procedure in FIG. 7. The difference is essentially that step S33 is executed in the NO branch of step S37 and there is then a return to step S34 and furthermore after the execution of step S32 a step S38 is first executed. Otherwise the procedure in FIG. 9 corresponds to that in FIG. 7.

In step S38 the computing device 10 sets the jerk limit value RG for the selected position-controlled axis 2 to a start value, i.e. an initial jerk. The first execution of step S34 is thus effected by limiting the movements to the initial jerk. The computing device 10 sets the initial jerk to a value between the lower jerk limit RUG and the upper jerk limit ROG of the selected position-controlled axis 2, mostly to a mean value between the lower jerk limit RUG and the upper jerk limit ROG of the selected position-controlled axis 2. For the initial jerk, the following values are in particular suitable;
the geometric mean of lower jerk limit RUG and upper jerk limit ROG (geometric mean=forming the product and extracting the root),
the arithmetic mean of lower jerk limit RUG and upper jerk limit ROG (arithmetic mean=forming the sum and dividing by 2) and
values between the geometric and the arithmetic mean from the lower jerk limit RUG and the upper jerk limit ROG.

The procedure in accordance with FIG. 10 is substantially similar to the procedure in FIG. 7. In accordance with FIG. 10 the computing device 10 first activates the setpoint filter 7 of the selected position-controlled axis 2 in a step S41. For example, the computing device 10 can transmit a corresponding control signal to the numerical control system 3. In a step S42 the computing device 10 determines a lower frequency limit fUG and an upper frequency limit fOG for the selected position-controlled axis 2.

In a step S43 the computing device 10 receives a determination of the filter frequency fF from the operator 13. The specification of the filter frequency fF by the operator 13 is here permissible only within the interval determined by the lower frequency limit fUG and the upper frequency limit fOG. The specification of a filter frequency fF by the operator 13 outside the interval determined by the lower frequency limit fUG and the upper frequency limit fOG is refused by the computing device 10. In a step S44 the computing device 10—similarly to step S34 in FIG. 7—initiates movements of the respective position-controlled axis 2. For these movements the computing device 10 limits the jerk to the (previously) determined jerk limit value RG and furthermore takes into account the filter frequency fF received.

In a step S45 the computing device 10—similarly to step S35 in FIG. 7 receives from the numerical control system 3 the time curves of the actual position values x of the selected position-controlled axis 2 which are produced or effected by the movement commands. In a step S46 the computing device 10 displays the corresponding time curve of the actual position value x of the respective position-controlled axis 2. The representation is similar to that in FIG. 8.

In a step S47 the computing device 10 checks whether an OK signal has been specified to it by the operator 13. If so, the computing device 10 adopts the last-received filter frequency fF as a determined filter frequency fF. Otherwise the computing device 10 returns to step S43 and receives from the operator 13 a modified determination of the filter frequency fF. It is possible that when step S43 is executed anew (within the permissible interval) a free specification of the filter frequency fF is possible. Preferably, however, based on the last-specified filter frequency fF, only a change by a certain extent is possible, for example by a maximum of 5% or a maximum of 10% or a maximum of 20% of the size of the permissible interval.

FIG. 11 shows a slight modification of the procedure in FIG. 10. The modification is analogous to the modification in FIG. 9 compared to the procedure in FIG. 7. The difference is thus essentially that step S43 is executed in the NO branch of step S47 and there is then a return to step S44 and furthermore after the execution of step S42 a step S48 is first executed. Otherwise the procedure In FIG. 11 corresponds to that in FIG. 10.

In step S48 the computing device 10 sets the filter frequency fF for the selected position-controlled axis 2 to a start value, I.e. an initial frequency. The first execution of step S44 is thus effected by taking into account the initial frequency. The computing device 10 sets the initial frequency to a value between the lower frequency limit fUG and the upper frequency limit fOG of the selected position-controlled axis 2, mostly to a mean value between the lower frequency limit fUG and the upper frequency limit fOG of the selected position-controlled axis 2. For the initial frequency-analogously to the initial jerk-the geometric mean, the arithmetic mean and values between the geometric and the arithmetic mean of the lower frequency limit fUG and upper frequency limit fOG are in particular suitable.

As explained so far, the determination of the jerk limit value RG and of the filter frequency fF for the respectively selected position-controlled axis 2 is effected in the same manner. The difference is in which values are accepted by the computing device 10 as permissible, i.e. ultimately the determination of the lower jerk limit RUG and the upper jerk limit ROG as well as of the lower frequency limit fUG and the upper frequency limit fOG by the computing device 10.

Specifically for the first-selected position-controlled axis 2—as ultimately the position-controlled axis 2 at which the lowest characteristic frequency fE has the smallest value—the computing device 10 determines the lower jerk limit RUG, the upper jerk limit ROG, the lower frequency limit fUG and the upper frequency limit fOG by taking into account the lowest characteristic frequency fE of the first-selected axis 2. Other dependencies are generally not taken into account. For example, for the determination of the lower jerk limit RUG the computing device 10 can multiply the lowest characteristic frequency fE of the first-selected axis 2 by an appropriate factor and use the resulting value as a lower jerk limit RUG. Analogously, the computing device 10 can also determine the upper jerk limit ROG, the lower frequency limit fUG and the upper frequency limit fOG by taking into account the lowest characteristic frequency fE of the first-selected axis 2. The factors can obviously differ. In particular for the determination of the respective lower limit RUG, fUG and of the respective upper limit ROG, fOG factors differing from one another must of course be used.

To this end a numerical example is again given, once more starting from the example already given, in which the lowest characteristic frequency fE with the smallest value is 12 Hz. The numerical value “12” can for example be multiplied by the factor 0.5 and the result in the unit “m/s³” can be used as the lower jerk limit RUG. Analogously, the numerical value “12” can be multiplied by the factor 2.0 and the result in the unit “m/s³” can be used as the upper jerk limit ROG. In similar fashion—now without changing the unit and as required with the same factors as for the determination of the lower jerk limit RUG and the upper jerk limit ROG or with other factors—the lower frequency limit fUG and the upper frequency limit fOG can also be determined for the first-selected position-controlled axis 2.

In contrast, for the other position-controlled axes 2 the computing device 10 determines the lower jerk limit RUG and/or the upper jerk limit ROG by taking into account not only the lowest characteristic frequency fE of the respective selected axis 2, but additionally by taking into account the jerk limit value RG specifically determined for the first-selected position-controlled axis 2. For example, the computing device 10 can multiply the lowest characteristic frequency fE of the now selected axis 2 by an appropriate factor and multiply the jerk limit value RG for the first-selected position-controlled axis 2 by another appropriate factor. The computing device 10 can use the larger of the two resulting values as the lower jerk limit RUG. Analogously, the computing device 10 can multiply the lowest characteristic frequency fE of the now selected axis 2 by an appropriate factor and multiply the jerk limit value RG for the first-selected position-controlled axis 2 by another appropriate factor. The computing device 10 can use the smaller of the two resulting values as the upper jerk limit ROG.

Analogously, for the other position-controlled axes 2 the computing device 10 determines the lower frequency limit fUG and/or the upper frequency limit fOG by taking into account not only the lowest characteristic frequency fE of the respective selected axis 2, but by additionally by taking into account the filter frequency fF specifically determined for the first-selected position-controlled axis 2. For example, the computing device 10 can multiply the lowest characteristic frequency fE of the now selected axis 2 by an appropriate factor and can multiply the filter frequency fF for the first-selected position-controlled axis 2 by another appropriate factor. The computing device 10 can use the larger of the two resulting values as the lower frequency limit fUG. Analogously, the computing device 10 can use the lowest characteristic frequency fE of the now selected axis 2 and multiply it by an appropriate factor and can multiply the filter frequency fF for the first-selected position-controlled axis 2 by another appropriate factor. The computing device 10 can use the smaller of the two resulting values as the upper frequency limit fOG.

In summary, the present invention thus relates to the following facts:

In order to parameterize a numerical control system 3, a computing device 10 coupled to the numerical control system 3 executes a workflow in which jerk limit values RG and filter frequencies fF for the position-controlled axes 2 are determined and transmitted to the numerical control system 3. Here the computing device 10 first transmits movement commands to the numerical control system 3 and receives resulting time curves for the actual position values x of the position-controlled axes 2. On the basis of this, lowest characteristic frequencies fE of the position-controlled axes 2 are determined. The position-controlled axes 2 are then selected individually one after the other and a respective jerk limit value RG and a respective filter frequency IF are determined by an operator 13. The determinations are limited by the computing device 10 to respective lower and upper limits RUG, fUG, ROG, fOG. For the first-selected position-controlled axis, 2 the computing device 10 determines the lower and upper limits RUG, fUG, ROG, fOG by taking into account the lowest characteristic frequency fE of the first-selected axis 2. For the other position-controlled axes 2, the determination is effected by taking into account the lowest characteristic frequency fE of the respective selected axis 2 and the jerk limit value RG determined for the first-selected position-controlled axis 2 or the filter frequency fF determined for the first-selected position-controlled axis 2.

The present invention has many advantages. Because the jerk limit value RG and the filter frequency fF are determined first for the position-controlled axis 2 with the lowest characteristic frequency fE with the smallest value and because these values are subsequently taken into account when determining the jerk limit value RG and the filter frequency fF of the other position-controlled axes 2, it is straightforwardly possible to determine the jerk limit value RG and the filter frequency fF for the position-controlled axes 2. In particular the required coordination of position-controlled axes 2 with one another and thus good contour accuracy is ensured. Because the jerk limit value RG for the respective position-controlled axis 2 is determined before the filter frequency fF for the respective position-controlled axis 2 is determined, a determination is straightforwardly possible here too. Because the resulting time curves of the actual position values x and the intellectual evaluation by the operator 13 are displayed as part of steps S35 and S45 it is possible to determine “good” values for the respective jerk limit value RG and the respective filter frequency fF easily and reliably. The vibration damping can be significantly improved in particular in the critical frequency range between 10 Hz and 50 Hz. At the same time, a comparatively high dynamic can be maintained. In normal operation of the numerical control system 3 the desired path B* can be traversed with a high level of accuracy and a high dynamic.

Although the invention has been illustrated and described in greater detail by the preferred exemplary embodiment, the invention is nevertheless not restricted by the disclosed examples and other variations can be derived therefrom by the person skilled in the art, without departing from the scope of protection of the invention.

1.-10. (canceled)

11. A method for parameterizing a numerical control system, comprising:
in a normal operation,
moving a tool of the machine tool relative to a workpiece to be machined by the tool with the numerical control system, along an actual path by coordinated control of multiple position-controlled axes of a machine tool, so that a maximum deviation of the actual path from an actually intended desired path as by a parts program is adhered to, wherein
the numerical control system adheres to jerk limit values of the position-controlled axes when moving the position-controlled axes and filters desired position values of the position-controlled axes before determining control values of the position-controlled axes in setpoint filters,
before the normal operation is executed, determining in a computing device coupled to the numerical control system as part of a workflow the jerk limit values for the position-controlled axes and filter frequencies for the setpoint filters and transmitting the jerk limit values and the filter frequencies from the computing device to the numerical control system,
and further, as part of the processing of the workflow, with the computing device
determining based on an input by an operator movement commands for the position-controlled axes and transmitting the movement commands to the numerical control system, and moving with the numerical control system the position-controlled axes commensurate with the transmitted movement commands, and receiving from the numerical control system time curves produced by the movement commands for the actual position values of the position-controlled axes,
based on the received time curves of the actual position values, determining lowest characteristic frequencies of the position-controlled axes or outputting a preliminary evaluation of the time curves of the actual position values to the operator, and receiving such a determination from the operator,
selecting the position-controlled axes individually and sequentially, and receiving from the operator a determination of the jerk limit value and of the filter frequency for the respectively selected position-controlled axis, and
transmitting the determined jerk limit values and the determined filter frequencies to the numerical control system,
determining the respective jerk limit value only between a lower jerk limit and an upper jerk limit, and allowing determining the respective filter frequency only between a lower frequency limit and an upper frequency limit,
determining the lower jerk limit and the upper jerk limit as well as the lower frequency limit and the upper frequency limit for the first-selected position-controlled axis by taking into account the lowest characteristic frequency of the first-selected axis, and
determining the lower jerk limit or the upper jerk limit for the other position-controlled axes by taking into account the lowest characteristic frequency of the respective selected of the other position-controlled axes and the jerk limit value determined for the first-selected position-controlled axis, and determining the lower frequency limit or the upper frequency limit by taking into account the lowest characteristic frequency of the respective selected of the other position-controlled axes and the filter frequency determined for the first-selected position-controlled axis.

12. The method of claim 11, further comprising receiving by the computing device from the operator for a respectively selected position-controlled axis first the determination of the jerk limit value and only thereafter the determination of the filter frequency.

13. The method of claim 11, further comprising:
deactivating with the computing device the respective setpoint filter for determining the respective jerk limit value, and iteratively
receiving from the operator a determination of the jerk limit value,
initiating movements of the respective position-controlled axis by observing limits to the received jerk limit value, and
displaying to the operator the resulting time curve of the actual position value of the respective position-controlled axis,
until a command is transmitted by the operator to the computing device to adopt the last-received jerk limit value as the determined jerk limit value.

14. The method of claim 13, further comprising:
before the operator determines the jerk limit value, determining the jerk limit value with the computing device to an initial jerk,
initiating movements of the respective position-controlled axis limited to the initial jerk, and
displaying the resulting time curve of the actual position value of the respective position-controlled axis to the operator.

15. The method of claim 14, further comprising determining the initial jerk with the computing device to a value between the lower jerk limit and the upper jerk limit of the selected position-controlled axis.

16. The method of claim 15, wherein the value between the lower jerk limit and the upper jerk limit is a mean value.

17. The method of claim 11, further comprising:
with the computing device, activating the respective setpoint filter to determine the respective filter frequency, and iteratively
receiving from the operator a determination of the filter frequency,
initiating movements of the respective position-controlled axis limited to the determined jerk limit value and by taking into account the received filter frequency, and
displaying the resulting time curve of the actual position value of the respective position-controlled axis to the operator,
until the operator transmits a command to the computing device to adopt the last-received filter frequency as the determined filter frequency.

18. The method of claim 17, further comprising:
before the filter frequency is first determined by the operator, determining the filter frequency with the computing device to an initial frequency,
initiating movements of the respective position-controlled axis limited to the determined jerk limit value and by taking into account the initial frequency, and
displaying the resulting time curve of the actual position value of the respective position-controlled axis to the operator.

19. The method of claim 18, further comprising with the computing device, determining the initial frequency to a value between the lower frequency limit and the upper frequency limit of the selected position-controlled axis.

20. The method of claim 19, wherein the value between the lower frequency limit and the upper frequency limit is a mean value.

21. A computer program stored on a non-transitory medium and including machine code with program instructions that when read into a memory of a computing device coupled to a numerical control system and executed by the computing device, causes the computing device to perform a method for parameterizing a numerical control system, with the method comprising in a normal operation,
moving a tool of the machine tool relative to a workpiece to be machined by the tool with the numerical control system, along an actual path by coordinated control of multiple position-controlled axes of a machine tool, so that a maximum deviation of the actual path from an actually intended desired path as by a parts program is adhered to, wherein
the numerical control system adheres to jerk limit values of the position-controlled axes when moving the position-controlled axes and filters desired position values of the position-controlled axes before determining control values of the position-controlled axes in setpoint filters,
before the normal operation is executed, determining in a computing device coupled to the numerical control system as part of a workflow the jerk limit values for the position-controlled axes and filter frequencies for the setpoint filters and transmitting the jerk limit values and the filter frequencies from the computing device to the numerical control system,
and further, as part of the processing of the workflow, with the computing device
determining based on an input by an operator movement commands for the position-controlled axes and transmitting the movement commands to the numerical control system, and moving with the numerical control system the position-controlled axes commensurate with the transmitted movement commands, and receiving from the numerical control system time curves produced by the movement commands for the actual position values of the position-controlled axes,
based on the received time curves of the actual position values, determining lowest characteristic frequencies of the position-controlled axes or outputting a preliminary evaluation of the time curves of the actual position values to the operator, and receiving such a determination from the operator,
selecting the position-controlled axes individually and sequentially, and receiving from the operator a determination of the jerk limit value and of the filter frequency for the respectively selected position-controlled axis, and
transmitting the determined jerk limit values and the determined filter frequencies to the numerical control system,
determining the respective jerk limit value only between a lower jerk limit and an upper jerk limit, and allowing determining the respective filter frequency only between a lower frequency limit and an upper frequency limit,
determining the lower jerk limit and the upper jerk limit as well as the lower frequency limit and the upper frequency limit for the first-selected position-controlled axis by taking into account the lowest characteristic frequency of the first-selected axis, and
determining the lower jerk limit or the upper jerk limit for the other position-controlled axes by taking into account the lowest characteristic frequency of the respective selected of the other position-controlled axes and the jerk limit value determined for the first-selected position-controlled axis, and determining the lower frequency limit or the upper frequency limit by taking into account the lowest characteristic frequency of the respective selected of the other position-controlled axes and the filter frequency determined for the first-selected position-controlled axis.

22. A computing device coupled to a numerical control system and programmed with the computer program of claim 21.
